(19) United States
(12) Patent Application Publication
(10) Pub. No.: US 2018/0128212 A1
(43) Pub. Date: May 10, 2018

(54) Device and Method for Injecting Water of an Internal Combustion Engine

(71) Applicant: Robert Bosch GmbH, Stuttgart (DE)

(72) Inventors: Ingmar Burak, Stuttgart (DE); Peter Schenk, Ludwigsburg (DE)

(73) Assignee: Robert Bosch GmbH, Stuttgart (DE)

(21) Appl. No.: 15/571,408

(22) PCT Filed: Apr. 18, 2016
(86) PCT No.: PCT/EP2016/058493

§ 371 Date: Nov. 2, 2017

(30) Foreign Application Priority Data
May 7, 2015 (DE) 10 2015 208 477.9

(51) Int. Cl. F02M 25/022

(52) U.S. Cl. CPC F02M 25/0222; C02F 1/325; F02M 25/0224

(57) ABSTRACT

A device for injecting water of an internal combustion engine includes a water tank, at least one water injector, at least one UV lamp, and a control unit. The water tank is configured to store water. The water injector is connected to the water tank and is configured to inject the water. The UV lamp is configured to emit ultraviolet radiation. The control unit is configured to switch on the UV lamp to decontaminate the water with the emitted ultraviolet radiation, and to switch on the water injector to inject the decontaminated water.

### PRIOR ART

The present invention relates to a device for injecting water of an internal combustion engine as well as such an internal combustion engine. A further aspect of the invention relates to a method for injecting water by means of a water injection device according to the invention.

As a result of increasing demands in terms of reduced carbon dioxide emissions, internal combustion engines are increasingly being optimized in terms of fuel consumption. However, known internal combustion engines cannot be operated optimally in terms of consumption at operating points with high load since operation is restricted by knocking and high exhaust gas temperatures. One possible measure to reduce knocking and lower the exhaust gas temperatures is the injection of water. In this case, separate water injection systems are normally present in order to enable the injection of water. A water injection system for an internal combustion engine with exhaust gas recirculation is known e.g. from WO 2014/080266 A1 in the case of which the water is injected into the mass flow of the exhaust gas recirculation.

One problem in the case of known water injection systems is a possible impairment of their function by contamination which can be caused by contaminants in the water used. These contaminants promote the formation of algae and fungi as well as the growth of cyanobacteria, acetobacter or other micro-organisms. Contamination or biocontamination arises in particular in the water tank in the case of a medium which has been stationary for an extended period of time. Chemical products or coatings are used in known water injection systems in order to avoid contamination or to neutralize existing contamination. However, this can lead to a malfunction of the components and even failure as well a blocking of filters which are arranged in the water injection system.

### DISCLOSURE OF THE INVENTION

The device according to the invention for injecting water of an internal combustion engine with the features of claim 1 has the advantage over this that contamination or biocontamination can be reduced or eliminated by irradiating the water by means of ultraviolet radiation. This can be achieved according to the invention by a device for injecting water, which comprises a water tank for storing water, at least one water injector for injecting water which is connected to the water tank, a control unit and at least one UV lamp which is configured to emit ultraviolet radiation. According to the invention, the control unit is configured to switch on the UV lamp for decontamination of the water, and inject the decontaminated water. Decontamination by means of ultraviolet radiation provides a high sterilization capacity. This method of decontamination is furthermore ecologically safe, efficient, reliable and operation-friendly which leads to high cost-effectiveness of the method. The cost-effectiveness of the decontamination method can furthermore preferably be controlled via the radiation dose, as a result of which the method can be adapted to the respective requirements. In addition to a remanufacture of a device according to the invention for the injection of water, simple retrofitting of an existing water injection system with a UV lamp according to the invention is possible.

The subordinate claims show preferred further developments of the invention.

The UV lamp is particularly preferably arranged in the water tank. As a result, a compact structure of the device for injection of water is enabled.

According to one advantageous configuration of the invention, the UV lamp is arranged above a maximum water level of the water tank. Rapid irradiation of the water is thus achieved. Moreover, a complicated sealing off of the UV lamp can be omitted. The maximum water level refers to the maximum level of the water in the water tank which is available for injection.

According to a further preferred configuration of the invention, the UV lamp can be arranged below the maximum water level of the water tank. The size of the water tank can be further reduced as a result.

In the context of the invention, the UV lamp can preferably be arranged partially above and partially below the maximum water level of the water tank. Such an arrangement has a combination of the advantageous effects, described above, of the arrangement of the UV lamp above and below the maximum water level.

The UV lamp can preferably be arranged adjustably in the water tank. The UV lamp can thus be moved into the correct position in the water tank depending on the application or water tank design, which leads to optimum decontamination of the water. An adjustment of the UV lamp in the water tank can be carried out at the start of or during the contamination process.

It can furthermore be advantageous if a fill level sensor is provided for identifying a fill level of the water tank. The UV lamp can thus be switched on for a predetermined time on the basis of an identified fill level of the water tank. An identified fill level of the water tank can furthermore be used for an adjustment of the UV lamp in the water tank.

The device advantageously further comprises a conveying element for conveying the water, wherein the conveying element is connected by means of a first line to the water tank and by means of a second line to the water injector, wherein the UV lamp is arranged in the first line or in the second line.

According to a yet further preferred configuration of the invention, the control unit is configured to supply water condensate of an air-conditioning system and/or refilling water via a filling line into the water tank, wherein the UV lamp is arranged on the fill line upstream of the water tank. The arrangement of the UV lamp outside the water tank on the filling line offers flexibility when arranging the UV lamp, in particular in the case of limited available space, in the water injection system.

The device for injecting water further preferably has a first filter element which is provided in the filling line, in particular downstream after the UV lamp.

The device according to the invention preferably comprises a second filter element which is provided in the first line, in particular in a line portion which lies in the water tank. The second filter element can furthermore be disinfected by means of the ultraviolet radiation.

By combining a UV lamp and the first and/or second filter element, it is ensured that the water to be injected is free from contaminants and micro-organisms.

A further aspect of the present invention relates to an internal combustion engine which comprises a device for injecting water according to the invention.

The internal combustion engine according to the present invention is particularly preferably operated according to the Otto principle and with petrol. Such an internal combustion engine is to be understood as the internal combustion engine in which combustion of petrol or a petrol/air mixture is carried out by external ignition in the form of a spark plug. Since, in the case of such an internal combustion engine, the time of ignition is precisely predetermined by the external ignition and combustion is improved by the injection of water, fail-safe functioning of the internal combustion engine is achieved by the use of ultraviolet radiation to decontaminate the water.

In particular, the device according to the invention is used in an internal combustion engine with direct petrol injection and turbocharging.

The present invention furthermore relates to a method for injecting water into an internal combustion engine, wherein the water is decontaminated by means of a UV lamp which emits ultraviolet radiation and is injected by means of a water injection device. The advantages described in relation to the device according to the invention for injection of water are associated with this.

The UV lamp is preferably switched on cyclically or permanently.

In particular if the UV lamp is arranged in a water tank of the water injection device, it is ensured by a cyclical or periodic or permanent irradiation of the water that the water reaches the water injector without micro-organisms and/or contaminants.

The UV lamp is advantageously switched on if water condensate is supplied from an air-conditioning system and/or refilling water into the water tank. The water can thus be contaminated in a targeted manner. The energy costs for operating the UV lamp can be reduced as a result.

### BRIEF DESCRIPTION OF THE DRAWINGS

Exemplary embodiments of the invention are described in detail below with reference to the enclosed drawing, wherein identical or functionally identical parts are designated in each case by the same reference number. In the drawing:

FIG. 1 shows a greatly simplified schematic view of an internal combustion engine with a device for injecting water according to a first exemplary embodiment of the present invention,

FIG. 2 shows a simplified schematic view of the device according to the first exemplary embodiment,

FIG. 3 shows a greatly simplified schematic view of the device according to a second exemplary embodiment, and

FIG. 4 shows a greatly simplified schematic view of the device according to a third exemplary embodiment.

### EMBODIMENTS OF THE INVENTION

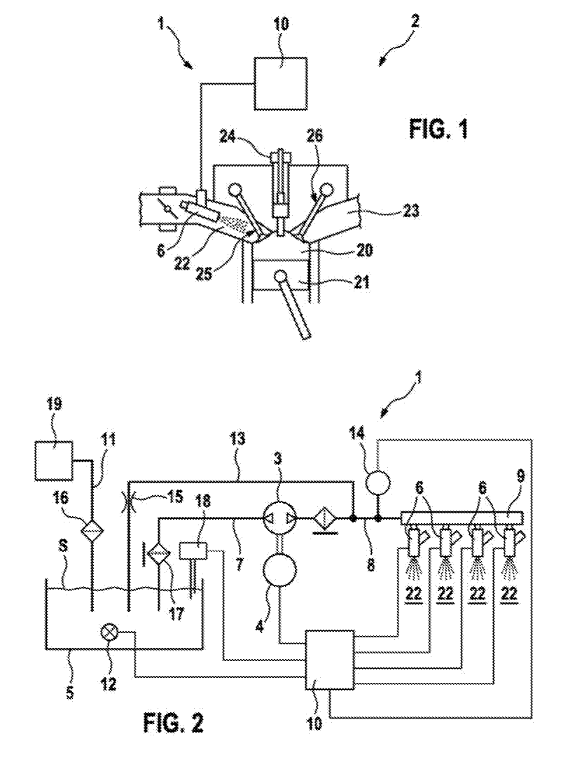

A device 1 for injecting water of an internal combustion engine 2 according to a first exemplary embodiment is described in detail below with reference to FIGS. 1 and 2. In particular, internal combustion engine 2 is operated according to the Otto principle and with direct petrol injection.

Internal combustion engine 2 is represented schematically in FIG. 1, which internal combustion engine 2 has a plurality of cylinders. Internal combustion engine 2 comprises for each cylinder a combustion chamber 20 in which a piston 21 can be moved to and fro. Internal combustion engine 2 furthermore preferably has for each cylinder an inlet duct 22 via which air is supplied to combustion chamber 20. Exhaust gas is discharged via an exhaust gas duct 23. To this end, an inlet valve 25 is arranged on inlet duct 22 and an outlet valve 26 is arranged on exhaust gas duct 23. Reference number 24 furthermore designates a fuel injection valve.

A water injector 6 is furthermore arranged on inlet duct 22, which water injector 6 injects water into inlet duct 22 of internal combustion engine 2 via a control unit 10. In this exemplary embodiment, a water injector 6 is provided for each cylinder. Alternatively, one water injector can be arranged for each inlet valve for improved processing or to increase the maximum quantity of water which can be injected for each combustion cycle.

Device 1 according to the invention for the injection of water is shown in FIG. 2. Water injection device 1 comprises a conveying element 3, which is in the form of a pump, and an electrical drive 4 for driving pump 3. A water tank 5 is furthermore provided which is connected by a first line 7 to pump 3. A second line 8 connects pump 3 to a distributor 9 or a rail to which a plurality of water injectors 6 are connected.

For injection of water, water is supplied out of water tank 5 through pump 3 into water injectors 6. A condensate of air-conditioning system 19 is preferably used for this, to which end device 1 according to the invention has a filling line 11 for the injection of water.

Alternatively or additionally to the condensate, deionized water can be conveyed from a refilling tank, not shown, into water tank 5. A first filter element 16 is arranged in filling line 11 and a second filter element 17 is arranged in first line 7.

A pressure controller 15 in the form of a gate is arranged in a return line 13 for adjustment of the desired system pressure in distributor 9, which return line 13 connects second line 8 to water tank 5. Pressure controller 15 can alternatively be formed as a check valve. Moreover, a pressure sensor 14 is provided in second line 8 for pressure control.

Water tank 5 is represented in FIG. 2 with water at a maximum water level S. A UV lamp 12 is arranged according to the invention within water tank 5. UV lamp 12 is configured to emit ultraviolet radiation and is switched on via control unit 10 in order to decontaminate the water in water tank 5. UV lamp 12 is, in this exemplary embodiment, switched on periodically at predetermined intervals. Alternatively, UV lamp 12 can be operated permanently in order to ensure that no contamination occurs in water tank 5.

UV lamp 12 is furthermore arranged adjustably in water tank 5. UV lamp 12 can thus, depending on the application, be positioned in such a manner that optimum decontamination of the water is carried out.

A fill level sensor 18 is furthermore provided in device 1. Fill level sensor 18 serves to identify a water fill level of water tank 5. The identified water fill level can serve to control UV lamp 12. E.g. a point in time and/or the duration of the switching on of UV lamp 12 can be specified depending on the identified water fill level. Moreover, UV lamp 12 can be adjusted on the basis of the identified water fill level so that UV lamp 12 is e.g. always below the current water level in water tank 5.

As a result of the UV lamp, it is made possible that the water of water injection device 1 is disinfected in an ecologically safe and simple manner. Blocking of filter elements 16, 17 can thus furthermore be avoided which leads to the required quantity of water to be injected being available. A fail-safe function of internal combustion engine 2 is thus ensured.

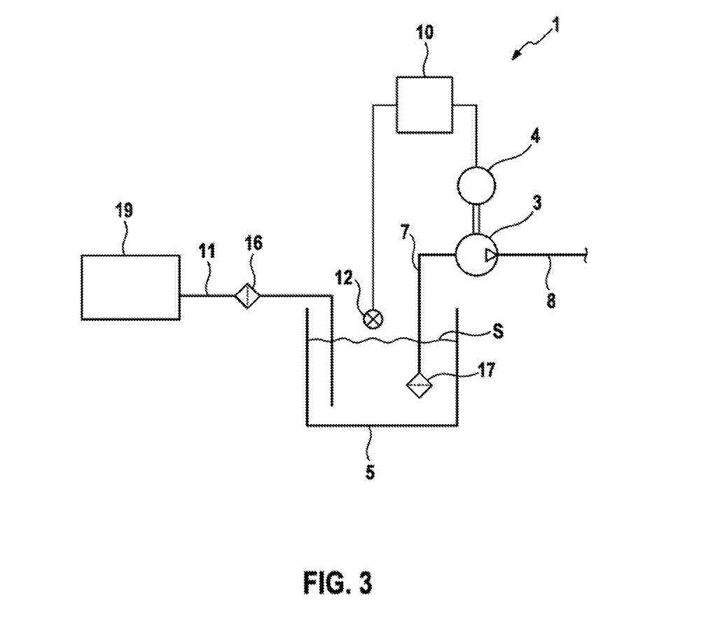

FIG. 3 shows a greatly simplified view of water injection device 1 according to a second exemplary embodiment of the present invention in which some components of device 1 are omitted. The second exemplary embodiments differs from the first exemplary embodiment from FIGS. 1 and 2 in principle in that UV lamp 12 is arranged in water tank 5 above maximum water level S. This arrangement has the advantage of rapid and uniform irradiation of the water located in water tank 5. Since UV lamp 12 is not lowered in the water, additional costs as a result of complicated sealing off of UV lamp 12 can be avoided.

Second filter element 17 is furthermore positioned below maximum water level S. Second filter element 17 can thus be decontaminated by UV lamp 12.

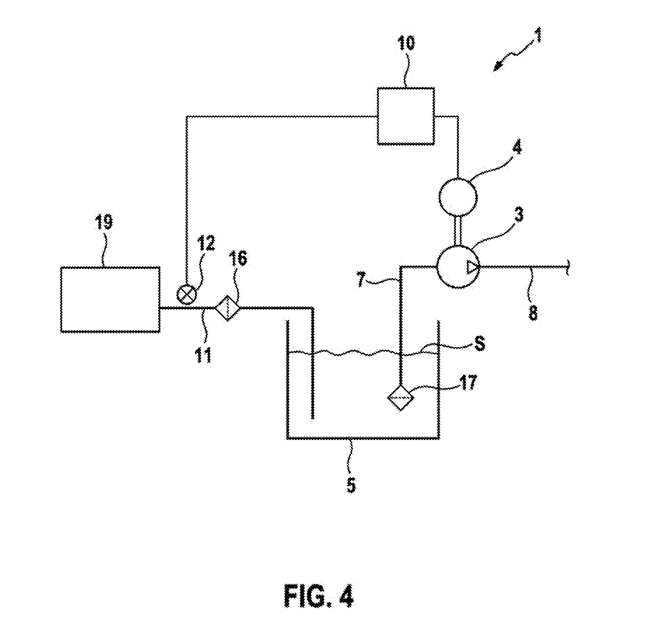

A device 1 for the injection of water according to a third exemplary embodiment of the present invention is shown in FIG. 4. In this case, UV lamp 12 is arranged on filling line 11. Filling line 11 connects air-conditioning system 19, in particular an evaporator of air-conditioning system 19, to water tank 5. UV lamp 12 is furthermore preferably arranged in the direction of the supply of water into water tank 5 upstream of first filter element 16.

UV lamp 12 is switched on if water condensate is supplied from air-conditioning system 19 into water tank 5. A targeted decontamination of the water thus takes place, as a result of which reduced operating costs are possible.

Although water injection device 1 according to the described exemplary embodiments only has one UV lamp 12, it is possible in the context of the invention to use a plurality of UV lamps which can be arranged in lines 7, 8, 11 and 13 and in water tank 5. As a result, it can be ensured that the water to be injected is decontaminated at all times. This brings about a fail-safe functioning of internal combustion engine 2.

1. A device for injecting water of an internal combustion engine, comprising:
a water tank configured to store water;
at least one water injector connected to the water tank and configured to inject the water;
at least one UV lamp configured to emit ultraviolet radiation; and
a control unit configured to switch on the at least one UV lamp to decontaminate the water with the emitted ultraviolet radiation, and to switch on the at least one water injector to inject the decontaminated water.

2. The device as claimed in claim 1, wherein the at least one UV lamp is disposed in the water tank.

3. The device as claimed in claim 2, wherein the at least one UV lamp is disposed above and/or below a maximum water level of the water tank.

4. The device as claimed in claim 2, wherein the at least one UV lamp is adjustably disposed in the water tank.

5. The device as claimed in claim 1, further comprising:
a fill level sensor configured to identify a fill level of the water tank.

6. The device as claimed in claim 1, further comprising:
a conveying element configured to convey the water;
a first line configured to connect the conveying element to the water tank; and
a second line configured to connect the conveying element to the at least one water injector,
wherein the at least one UV lamp is disposed in the first line or in the second line.

7. The device as claimed in claim 1, wherein:
the control unit is configured to supply water condensate of an air-conditioning system and/or refilling water via a filling line into the water tank; and
the at least one UV lamp is disposed on the filling line upstream of the water tank.

8. The device as claimed in claim 7, further comprising:
a filter element disposed in the filling line.

9. The device as claimed in claim 6, further comprising:
a filter element disposed in the first line.

10. An internal combustion engine, comprising:
a device configured to inject water including:
a water tank configured to store water;
at least one water injector connected to the water tank and configured to inject the water;
at least one UV lamp configured to emit ultraviolet radiation; and
a control unit configured to switch on the at last one UV lamp to decontaminate the water with the emitted ultraviolet radiation, and to switch on the at least one water injector to inject the decontaminated water.

11. The internal combustion engine as claimed in claim 10, wherein the internal combustion engine is configured to be operated according to the Otto principle and with petrol.

12. A method for injecting water into an internal combustion engine, comprising:
decontaminating the water with ultraviolet radiation emitted by at least one UV lamp; and
injecting the decontaminated water with at least one water injector.

13. The method as claimed in claim 12, further comprising:
switching on the at least one UV lamp cyclically or permanently.

14. The method as claimed in claim 13, further comprising:
switching on the at least one UV lamp in response to water condensate from an air-conditioning system and/or refilling water being supplied into a water tank.

15. The device as claimed in claim 8, wherein the filter element is disposed in the filling line downstream of the at least one UV lamp.

16. The device as claimed in claim 9, wherein the filter element is disposed in a portion of the first line located in the water tank.
